(19) United States
(12) Patent Application Publication
(10) Pub. No.: US 2002/0148448 A1
(43) Pub. Date: Oct. 17, 2002

(54) METHOD FOR OPERATING A FUEL INJECTOR

(76) Inventors: Hubert Stier, Asperg (DE); Norbert Keim, Loechgau (DE)

Correspondence Address: KENYON & KENYON, ONE BROADWAY, NEW YORK, NY, 10004, US

(21) Appl. No.: 09/958,370

(22) PCT Filed: Feb. 2, 2001
(86) PCT No.: PCT/DE01/00438

(30) Foreign Application Priority Data
Feb. 4, 2000 (DE) 100 05 015.8

(51) Int. Cl. H01H 9/00

(52) U.S. Cl. 123/490; 361/154

(57) ABSTRACT

A method is described for operating a fuel injector for fuel injection systems of internal combustion engines, particularly for the direct injection of fuel into a combustion chamber of an internal combustion engine, The fuel injector has a magnetic coil, an armature acted upon in a closing direction by a resetting spring, and a valve needle, frictionally connected to the armature, for actuating a valve-closure member which, together with a valve-seat surface , forms a sealing seat. The method includes the following method steps:

exciting the magnetic coil with a basic current intensity (I_{ba}) during an opening phase (t₂-t₁) of the fuel injector,

shortly before the end of the opening phase (t₂-t₁), exciting the magnetic coil with a current pulse (30) that is increased compared to the basic current intensity (I_{ba}),

at the end of the opening phase (t₂-t₁), switching off the current (I) exciting the magnetic coil.

### BACKGROUND INFORMATION

The present invention is based on a method for operating a fuel injector according to the species defined in the main claim.

An electromagnetically operable fuel injector for the direct injection of fuel into the combustion chamber of an internal combustion engine is already known from the German patent 196 26 576 A1, in which an armature cooperates with an electrically energizable magnetic coil for the electromagnetic actuation, and the lift of the armature is transferred via a valve needle to a valve-closure member. The valve-closure member cooperates with a valve-seat surface to form a sealing seat. The valve needle and the valve-closure member are reset by a resetting spring.

In particular, the relatively long closing times are disadvantageous in the fuel injector known from DE 196 26 576 A1. Delays in closing the fuel injector are caused by the adhesive powers acting between the armature and the core, and the non-instantaneous decay of the magnetic field in response to switching off the excitation current.

Therefore, the resetting spring must have a large spring constant or a great bias (prestressing). To achieve shorter closing times, the restoring force must be dimensioned to be substantially greater than would be necessary for sealing against the combustion chamber pressure. This involves a great power demand of the electronic trigger circuit.

### SUMMARY OF THE INVENTION

In contrast, the method of the present invention for operating a fuel injector, having the features of the main claim, has the advantage that an additional current pulse at the end of the opening phase has a positive effect on the closing operation. In the final phase of the opening interval, the total spring energy acting in the closing direction is increased by the additional current pulse.

Advantageous further refinements and improvements of the method indicated in the main claim are rendered possible by the measures specified in the dependent claims.

Due to the additional cutoff spring, an additional accelerative force is available during the closing operation to quickly close the fuel injector. The spring constant of the resetting spring is dimensioned in such a way that the spring energy exerted still safely suffices to seal the fuel injector against the pressure in the combustion chamber of the internal combustion engine.

The method is particularly advantageous in the low speed range of the internal combustion engine, since in this range, one strives for the metering of small amounts of fuel at relatively long time intervals.

Thermal overloading of the fuel injector and of the electrical component is virtually ruled out, since the current pulses are only supplied over very short periods of time with long pauses between.

By supplying a current pulse, the magnetic field is built up again to a higher magnetic-field value, which offers the advantage—relatively considered—of the rapid reduction in the periods of time relevant for the closing operation, since the magnetic field decreases approximately exponentially with the time.

The cutoff spring can be replaced by applying an elastically deformable layer on the armature stop face of the core and/or of the armature, since deformation energy can be stored in the elastically deformable layer which acts like a spring with a very high spring constant. This energy is available again for the closing operation.

### BRIEF DESCRIPTION OF THE DRAWINGS

A fuel injector suitable for carrying the method of the present invention into effect is explained in greater detail in the following description and is shown, simplified, in the Drawing, in which:

FIG. 1 in a sectional view, shows an exemplary embodiment of a fuel injector for implementing the method of the present invention; and

FIG. 2A, 2C show diagrams of the characteristics of the excitation current, of the spring energy and of the lift as a function of the trigger time for the method of the present invention.

### DESCRIPTION OF THE EXEMPLARY EMBODIMENT

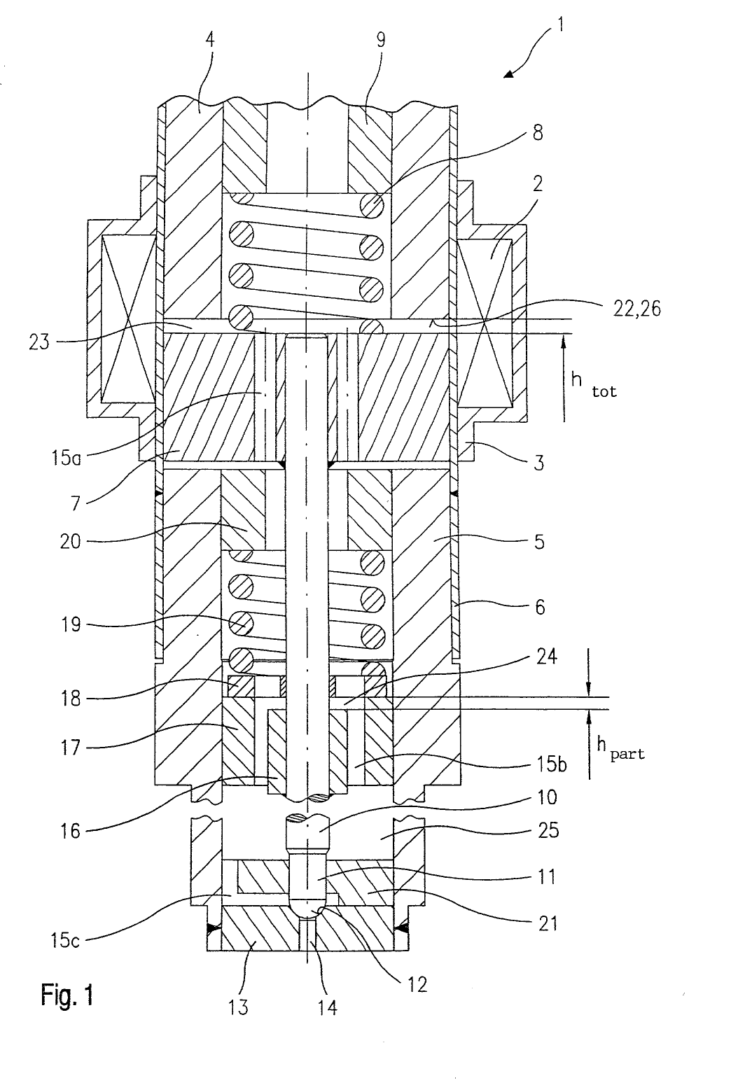

FIG. 1, in an axial sectional view, shows the region of a fuel injector 1 on the spray-discharge side. Fuel injector 1 is used, for example, for the direct injection of fuel into a combustion chamber (not shown) of a mixture-compressing internal combustion engine with externally supplied ignition, and is designed as an inwardly opening fuel injector 1.

Fuel injector 1 includes a magnetic coil 2, that is surrounded by a magnetic reflux member 3, as well as a core 4 and a nozzle body 5 that are surrounded by a valve housing 6. Arranged between core 4 and nozzle body 5 is an armature 7 that is acted upon by a resetting spring 8. Resetting spring 8 abuts at the extremity against an adjusting sleeve 9 which biases resetting spring 8. Armature 7 is connected frictionally and with form locking to a valve needle 10, at whose end on the spray-discharge side a valve-closure member 11 is formed. Valve-closure member 11, together with a valve-seat surface 12, forms a sealing seat. At least one spray orifice 14 is formed in a valve-seat member 13.

Valve needle 10 is guided in the region of the sealing seat by a guide element 21. The fuel is supplied centrally and is guided via fuel channels 15a, 15b, 15c to the sealing seat.

A tubular valve-needle end stop 16 is joined to valve needle 10. Situated on a bearing ring 17, which is applied on the inner wall of nozzle body 5 and can be pressed, for example, into a central opening 25 of fuel injector 1, is an axially movable ring 18 through which valve needle 10 protrudes. Supported on ring 18 is a cutoff spring 19 that is biased by a spring-adjusting ring 20 likewise applied on the inner wall of nozzle body 5. In fuel injector 1 shown in FIG. 1, cutoff spring 19 is constructed as helical spring 19.

A total lift hₜₒₜ corresponds to the size of a first working gap 23 formed between armature 7 and core 4. A partial lift hₚₐᵣₜ corresponds to the size of a second working gap 24 formed between valve-needle end stop 16 and movable ring 18. In the present example, partial lift hₚₐᵣₜ is approximately 90% of total lift hₜₒₜ.

If an electrical excitation current is supplied to magnetic coil 2, a magnetic field is built up which pulls armature 7 in the lift direction to core 4. Armature 7 takes along valve needle 10 joined to it. While armature 7 and valve needle 10 are passing through partial lift hₚₐᵣₜ, the magnetic-field strength only has to overcome the spring energy of weakly dimensioned resetting spring 8, so that armature 7 can be accelerated in the direction of core 4. The spring constant of resetting spring 8 is dimensioned in such a way that the spring energy safely suffices to seal fuel injector 1 against the combustion chamber (not shown) of an internal combustion engine.

After armature 7 and valve needle 10 joined to it have covered partial lift hₚₐᵣₜ, valve-needle end stop 16 strikes against movable ring 18 acted upon by cutoff spring 19.

As soon as armature 7 moves in the direction of core 4, valve-closure member 11 lifts off of valve-seat surface 12 and fuel is ejected via spray orifice 14.

During the opening phase, the striking of valve-needle end stop 16 against ring 18 limits the valve lift, so that valve-closure member 11 in the open state of fuel injector 1 is only raised by the amount of partial lift hₚₐᵣₜ.

Shortly before fuel injector 1 is closed, residual lift hₜₒₜ-hₚₐᵣₜ is covered against the spring energies of resetting spring 8 and cutoff spring 19, which is achieved by a short-duration increase, in the form of a current pulse, of the current exciting magnetic coil 2,. Armature 7 and valve needle 10 are raised by this current pulse shortly before the end of the opening phase, whereby valve-needle end stop 16 lifts movable ring 18 from bearing ring 17 in the lift direction against the spring energy of cutoff spring 19. Since the spring energies of resetting spring 8 and of cutoff spring 19 add up, the total spring energy of resetting spring 8 and of cutoff spring 19 is available at the end of the opening phase for closing fuel injector 1, this total spring energy, due to the large spring constant of cutoff spring 19, being considerably greater than the restoring force achieved in the related art by single resetting spring 8.

If the electrical excitation current exciting magnetic coil 2 is switched off, the magnetic field breaks down and armature 7 falls off of core 4. This can happen very quickly, since the total spring energy of resetting spring 8 and of cutoff spring 19 together accelerate armature 7 in the closing direction, enabling valve needle 10 to return very quickly to its closed position.

This effect can also be achieved by applying an elastically deformable layer 26 on an armature stop face 22 of core 4 and/or on armature 7, so that cutoff spring 19 can be omitted. Elastically deformable layer 26 acts like a spring with extremely high spring stiffness, so that an elastic deformation of armature stop face 22 due to the current pulse leads to the rapid detachment of armature 7 from core 4, as well as a rapid closing movement of fuel injector 1.

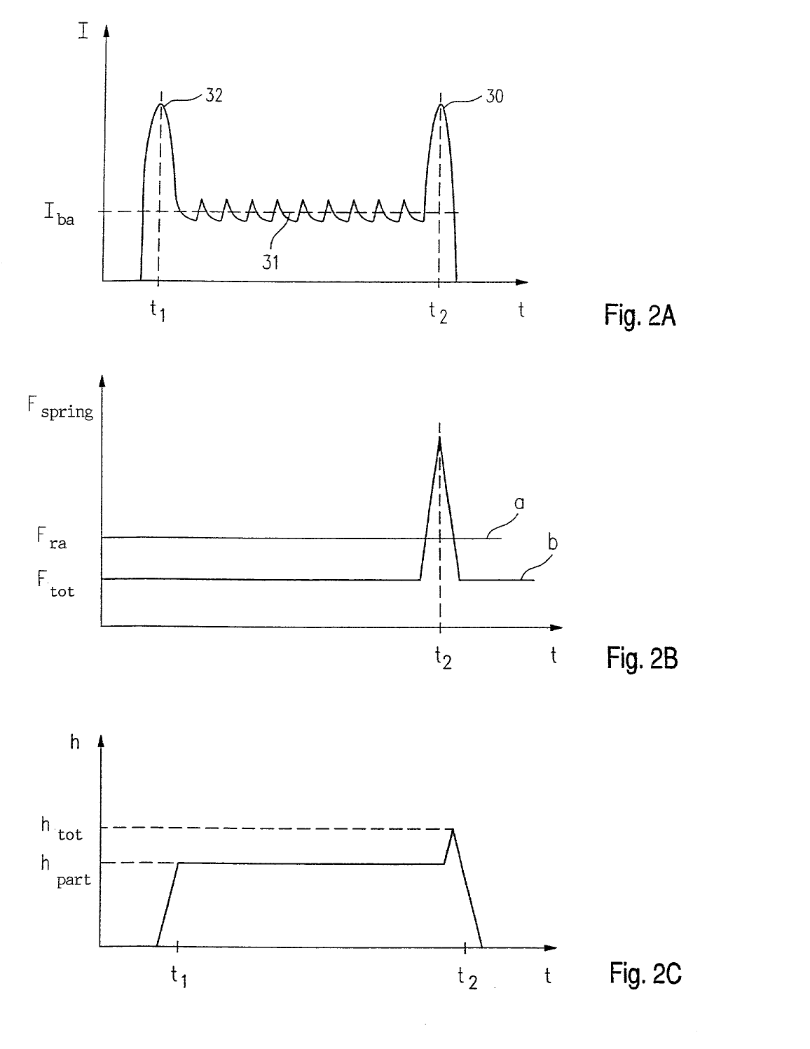

For the purpose of illustrating the operating mode of the current pulse, FIGS. 2A-2C show excitation current I, spring energy F_{spring} and valve lift h, in each case as a function of time t.

FIG. 2A shows current intensity I, exciting magnetic coil 2, as a function of time t. Following current pulse 32, supplied for initiating the opening operation, at instant t₁ is a phase 31 during which magnetic coil 2 is operated with a basic current intensity I_{ba} that is constant on average, until shortly before the end of the opening phase a current pulse 30 is again supplied at instant t₂ for overcoming cutoff spring 19. Excitation current I is thereupon switched off, which means after a brief time interval after sufficient reduction of the magnetic field, the closing operation begins. The brevity of current pulse 30 ensures that a maximum value for the electric power in the electrical trigger circuit is not exceeded, and consequently the electrical components are not damaged by thermal overloading.

FIG. 2B shows spring energy F_{spring} as a function of trigger time t. Diagram 2B includes a curve a which describes spring energy Fᵣₐ according to the related art using a single resetting spring 8, as well as a curve b which shows the dependence of total spring energy Fₜₒₜ of resetting spring 8 and of cutoff spring 19 as a function of time t for the example, described in FIG. 1, of a fuel injector 1 suitable for carrying out the method of the present invention.

Spring energy Fᵣₐ of resetting spring 8 in curve a is greater than spring energy Fₜₒₜ of resetting spring 8 in curve b, since the spring energy of resetting spring 8 according to the related art is the only force which pulls armature 7 from core 4 after sufficient decay of the magnetic field. In the case of fuel injector 1 suitable for carrying out the method of the present invention, the spring energy of resetting spring 8 is reduced to a value which is great enough to reliably seal fuel injector 1 against the pressure prevailing in the combustion chamber of the internal combustion engine. A shortened opening operation is thereby attained. The force necessary for the rapid closing is contributed by cutoff spring 19 which is overcome by current pulse 30, and consequently total spring energy Fₜₒₜ is increased for a short duration to a considerably greater value than in the related art due to supplied current pulse 30.

FIG. 2C shows valve lift h as a function of time t. The flow of current through magnetic coil 2 accelerates armature 7 against the spring energy of resetting spring 8 in the direction toward core 4. At instant t₁, the armature has passed through partial lift hₚₐᵣₜ. Valve-needle end stop 16 strikes against ring 18. Current intensity I now remains constant at value I_{ba}, fuel injector 1 thereby remaining in the partially opened position. Current intensity I_{ba} is not sufficient to move armature 7 against total spring energy Fₜₒₜ of resetting spring 8 and of cutoff spring 19 further in the direction toward core 4.

At instant t₂, shortly before the end of the opening phase, current pulse 30 is supplied which delivers the electrical power necessary to accelerate armature 7 and valve needle 10 against total spring energy Fₜₒₜ of resetting spring 8 and of cutoff spring 19 further in the direction toward core 4. Armature 7 strikes against core 4. Total spring energy Fₜₒₜ of resetting spring 8 and of cutoff spring 19 is now available for the closing operation.

The invention is not restricted to the example shown of a fuel injector 1 for carrying out the method of the present invention, and can also be implemented when working with a multitude of other types of construction of fuel injectors 1, particularly for fuel injectors 1 opening outwardly.

What is claimed is:

1. A method for operating a fuel injector (1) for fuel injection systems of internal combustion engines, particularly for the direct injection of fuel into a combustion chamber of an internal combustion engine,
the fuel injector (1) having a magnetic coil (2), an armature (7) acted upon in a closing direction by a resetting spring (8), and a valve needle (10), frictionally connected to the armature (7), for actuating a valve-closure member (11) which, together with a valve-seat surface (12), forms a sealing seat, comprising the following method steps:
exciting the magnetic coil (2) with a basic current intensity (I_{ba}) during an opening phase (t₂-t₁) of the fuel injector (1)
shortly before the end of the opening phase (t₂-t₁), exciting the magnetic coil (2) with a current pulse (30) that is increased compared to the basic current intensity
at the end of the opening phase (t₂-t₁), switching off the current (I) exciting the magnetic coil (2).

2. The method as recited in claim 1,
wherein a cutoff spring (19) is provided which cooperates with the resetting spring (8) in such a way that the spring energies of the resetting spring (8) and of the cutoff spring (19) add up after exceeding a partial lift (hₚₐᵣₜ) of the armature (7).

3. The method as recited in claim 1 or 2,
wherein at the end of the opening phase (t₂-t₁), the current pulse (30) acts upon the armature (7) and the valve needle (10) in such a way that the cutoff spring (19) becomes biased.

4. The method as recited in claim 1,
wherein an elastically deformable layer (26) is applied on an armature stop face (22) of the core (4) and/or of the armature (7).

5. The method as recited in one of claims 1 through 4,
wherein at the beginning of the opening phase (t₂-t₁), the magnetic coil (2) is excited by a further current pulse (32) that is increased compared to the basic current intensity (_{Iba}).

6. The method as recited in one of the preceding claims,
wherein the average electrical power of the current pulse (30), that is to say, of the current pulses (30, 32), does not exceed a predefinable maximum value.
